(19) United States
(12) Patent Application Publication
(10) Pub. No.: US 2006/0198953 A1
(43) Pub. Date: Sep. 7, 2006

(54) Process of forming special protecting structure for optical products

(75) Inventor: Yuan-Kai Tsai, Taoyuan County (TW)

Correspondence Address: YUAN-KAI TSAI;9F., No. 37, Dongsing Road, Xinyi District, Taipei City, 110, TW

(73) Assignee: LONGTIDE TECHNOLOGY CO., LTD.

(21) Appl. No.: 11/073,115

(22) Filed: Mar. 3, 2005

(51) Int. Cl. B05D 5/06

(52) U.S. Cl. 427/162; 427/240

(57) ABSTRACT

A specific material consisting of resin, monomer, photosensitizer, and assistant is spin coated on a surface of an optical product to form a protecting film through the steps of coating the specific material on the optical product and spinning the optical product; performing first, second, third, and fourth spinning, each with predetermined acceleration time, spin speed, and step time; stopping the spinning; drying the spin coated specific material by exposing it to ultraviolet rays to thereby form a uniform protecting film; and ending the steps.

### FIELD OF THE INVENTION

The present invention relates to a process of forming special protecting structure for optical products, such as compact disks, lens, lenses of eyeglasses, etc., and more particularly to a process of forming special protecting structure for optical products, in which a specific material consisting of resin, monomer, photosensitizer, and assistant is spin coated on a surface of the optical product to form a light transmissible, scratchproof, wear-resistant protecting film.

### BACKGROUND OF THE INVENTION

Most of the commercially available optical products, such as compact disks, lenses of eyeglasses, lenses of safety goggles, window lenses, watch crystals, liquid crystal displays of mobile phones, glare shields, for screens etc., are made to have beautiful and attractive appearances to capture consumers. These optical products, however, do not always have good quality and are easily scratched and damaged due to frictional contact with other articles. For example, a compact disk with a scratched and worn surface would have adverse influences on the correctness of data being read, and a scratched and worn eyeglass lens or watch crystal would have lowered clarity to largely reduce their uses. Therefore, scratchproof and wear-resistant finish is a very important link in the manufacturing of optical products.

For example, to read data on a general compact disk, a laser read-write head projects laser lights on a data layer at a data read-write side of the compact disk, and read data according to the state of laser lights reflected from the data layer. Thus, paths of the projected and the reflected laser lights have important influences on the correctness of data being read from the compact disk. However, most conventional compact disks do not have scratchproof and wear-resistant finish to protect their surfaces, and are frequently damaged due to frictional contact with one another when they are stacked. Particularly, one surface of a data storage layer of the conventional compact disk that is also provided for imprinting is frequently scratched when a user writes on that surface to result in a pressure that easily penetrates a surface paint of the imprinting surface to damage a reflection layer below it. Therefore, the conventional compact disks without scratchproof and wear-resistant structure fail to keep the data layer in a required flatness and tend to cause reading of incorrect data from the compact disks.

### SUMMARY OF THE INVENTION

A primary object of the present invention is to provide a process of forming special protecting structure for optical products to overcome the problems existed in the conventional optical products that do not have any scratchproof and wear-resistant finish. To achieve this object, the process of the present invention includes the steps of spin coating a material consisting of resin, monomer, photosensitizer, and assistant on a surface of an optical product; drying the spin-coated material by exposing it to ultraviolet rays, so as to form a light transmissible film having a relatively high hardness to be scratchproof and wear-resistant.

Another object of the present invention is to provide a process of forming special protecting structure for optical products, particularly for a side of a general compact disk at where a laser read-write head reads and writes data or a surface of a data storage layer of a general compact disk. To achieve this object, the process of the present invention includes the steps of spin coating a specific material on the data read-write side or the surface of the data storage layer of the compact disk; drying the spin-coated material by exposing it to ultraviolet rays, so as to form a light transmissible film having a relatively high hardness. The light transmissible film does not affect the read of data from the data read-write side of the compact disk by the laser read-write head, and maintains the data read-write side or the data storage layer of the compact disk in required flatness without being easily scratched and worn. The compact disk may therefore have an extended usable life.

A further object of the present invention is to provide a process of forming special protecting structure for optical products, in which a specific material is spin coated on a surface of a data read-write side of a compact disk having data to be read or written by a laser read-write head, and the spin-coated material is dried by exposing it to ultraviolet rays, so as to form a light transmissible film having a relatively high hardness. The process is characterized in that it does not affect or change properties of the data read-write side of the compact disk, and can therefore be performed after recording of data on the compact disk.

A still further object of the present invention is to provide a process of forming special protecting structure for optical products, in which a light transmissible protecting film is formed without affecting or changing properties of a data read-write side of a general compact disk to be read by a laser read-write head, and can therefore be formed before recording of data on the compact disk. The forming of the protecting film before recording of data on the compact disk enables the data read-write side to have better flatness. The higher the flatness of the data read-write side is, the more accurate a read angle of the laser read-write head will be. This not only ensures the correctness of data written into the compact disk, but also prevents the compact disk from scratches due to writing data thereinto and assures good recording quality of the compact disk.

A still further object of the present invention is to provide a process of forming special protecting structure for optical products, in which a specific material is spin coated on a data read-write side to be read and written by a laser read-write head or a surface of a data storage layer of a compact disk, and the spin-coated material is dried by exposing it to ultraviolet rays, so as to form a light transmissible protecting film. The specific material may be added with different colors, so that the resultant light transmissible protecting film presents different colors to provide a filtering effect and distinguish the compact disk from other ones.

A still further object of the present invention is to provide a process of forming special protecting structure for optical products, in which a specific material is spin coated on a data read-write side to be read and written by a laser read-write head or a surface of a data storage layer of a compact disk, and the spin-coated material is dried by exposing it to ultraviolet rays, so as to form a light transmissible protecting film. The process is simple and convenient to enable reduced manufacturing cost and accordingly increased competing ability of the compact disk in the market.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a flowchart showing the steps included in a process of forming special protecting structure for optical products according to a preferred embodiment of the present invention;

FIG. 2 shows a first example of application of the process of the present invention to a compact disk;

FIG. 3 shows a second example of application of the process of the present invention to a compact disk; and

FIG. 4 shows a third example of application of the process of the present invention to a compact disk.

### DETAILED DESCRIPTION OF THE PREFERRED EMBODIMENTS

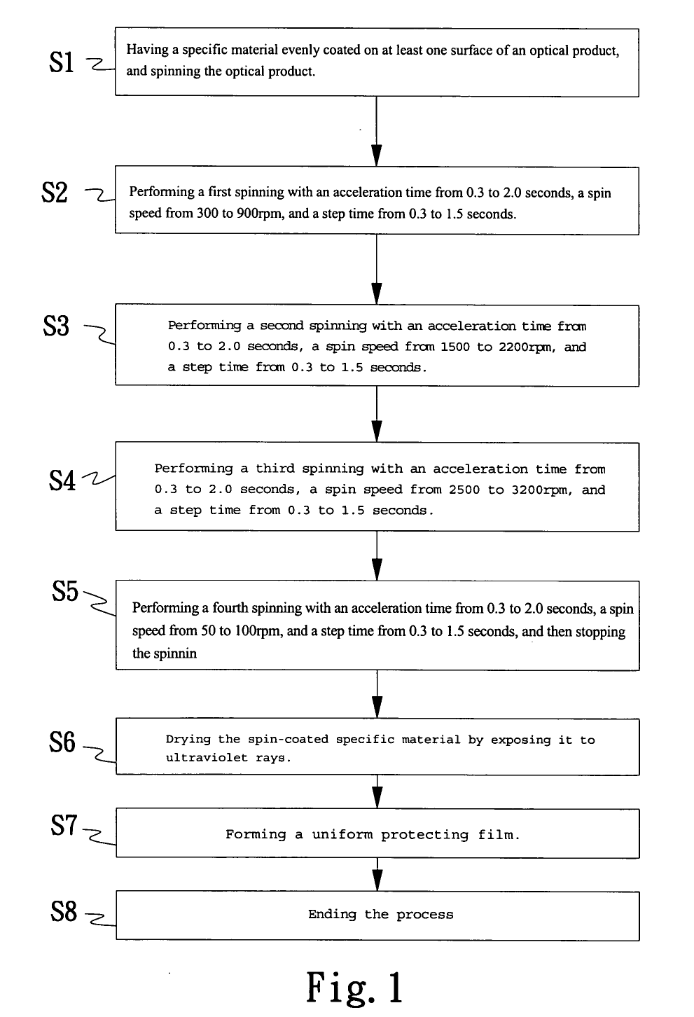

Please refer to FIG. 1 that is a flowchart showing the steps included in a process of forming special protecting structure for optical products according to a preferred embodiment of the present invention. In the process of the present invention, a specific material is spin coated on one or more surfaces of an optical product to form a protecting film thereat. The specific material for forming the protecting film consists of predetermined types of resin, monomer, photosensitizer, assistant, etc. As shown in FIG. 1, the process of the present invention includes at least the following steps:
(a) Having the specific material evenly coated on at least one surface of the optical product, and spinning the optical product (Step S1);
(b) Performing a first spinning with an acceleration time from 0.3 to 2 seconds, a spin speed from 300 to 900 rpm, and a step time from 0.3 to 1.5 seconds (Step S2);
(c) Performing a second spinning with an acceleration time from 0.3 to 2 seconds, a spin speed from 1500 to 2200 rpm, and a step time from 0.3 to 1.5 seconds (Step S3);
(d) Performing a third spinning with an acceleration time from 0.3 to 2 seconds, a spin speed from 2500 to 3200 rpm, and a step time from 0.3 to 1.5 seconds (Step S4);
(e) Performing a fourth spinning with an acceleration time from 0.3 to 2 seconds, a spin speed from 50 to 100 rpm, and a step time from 0.3 to 1.5 seconds (Step S5), and then stopping the spinning;
(f) Drying the specific material spin coated on the at least one surface of the optical product by exposing it to ultraviolet rays (Step S6);
(g) Forming a uniform protecting film (Step S7); and
(h) Ending the process (Step S8).

In the preferred embodiment of the process of the present invention, the amount of the resin presented in the specific material is in the range between 20% and 50%, the monomer between 10% and 30%, the photosensitizer between 1% and 15%, and the assistant between 0.5% and 5%. More specifically, the resin contained in the specific material of the present invention is selected from the group consisting of epoxy acrylic ester, phenolic resin, polymethyl acrylic resin, and any combinations thereof, the monomer from the group consisting of TMPTA, TPGDA, HDDA, etc., the photosensitizer from the group consisting of BDK, IRGACURE-907, ITX, BMS, IGGACURE-1173, DETX, etc., and the assistant from the group consisting of wax, fluorine-containing smoothening agent, silicone-type smoothening agent, organic silicon type assistant, etc.

The process of forming special protecting structure for optical products according to the present invention as shown in FIG. 1 may be applied to protect a compact disk. In this case, the specific material is spin coated on one or more surfaces of the compact disk to form a protecting film thereat. As mentioned above, the specific material for forming the protecting film consists of predetermined types of resin, monomer, photosensitizer, assistant, etc. And, the following steps are included:
1. Having the specific material evenly coated on at least one surface of the compact disk, and spinning the compact disk (Step S1);
2. Performing a first spinning with an acceleration time of 1.0 second, a spin speed of 900 rpm, and a step time of 1.5 seconds (Step S2);
3. Performing a second spinning with an acceleration time of 0.7 second, a spin speed of 2200 rpm, and a step time of 0.3 second (Step S3);
4. Performing a third spinning with an acceleration time of 0.3 second, a spin speed of 3200 rpm, and a step time of 1.5 seconds (Step S4);
5. Performing a fourth spinning with an acceleration time of 2.0 seconds, a spin speed of 100 rpm, and a step time of 0.3 second, and then stopping the spinning (Step S5);
6. Drying the specific material spin coated on the at least one surface of the compact disk by exposing it to ultraviolet rays (Step S6);
7. Forming a uniform protecting film (Step S7); and
8. Ending the process (Step S8).

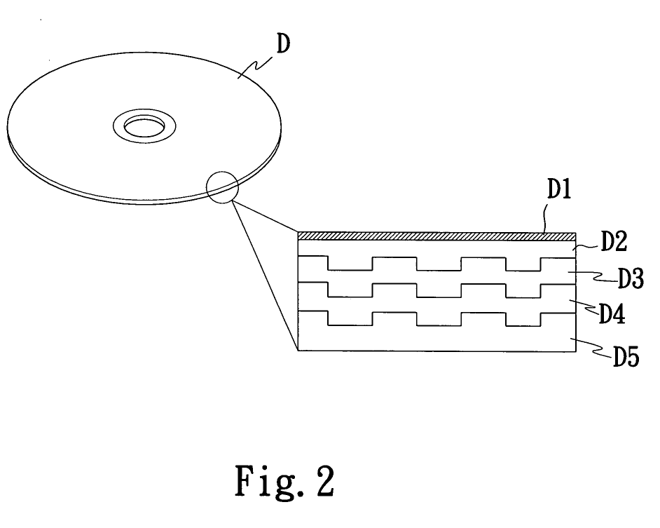

Please refer to FIG. 2 that shows a first example of application of the process of the present invention to a general compact disk D. In this first example, a light transmissible film D1 is coated on one side of the compact disk D. The compact disk D generally includes a bottom substrate D5 for protecting a record layer and serving as an imprinting side; a reflection layer D4 coated on a top of the bottom substrate D5 to reflect laser light signals; a dye layer D3 coated on a top of the reflection layer D4 to absorb laser lights and thereby form pits thereon as records; and an upper substrate D2 coated on a top of the dye layer D3 to allow laser lights from a laser read-write head to project therethrough for reading data on the compact disk. The light transmissible film D1 is coated on an outer side of the upper substrate D2 to protect the latter against scratch and wearing.

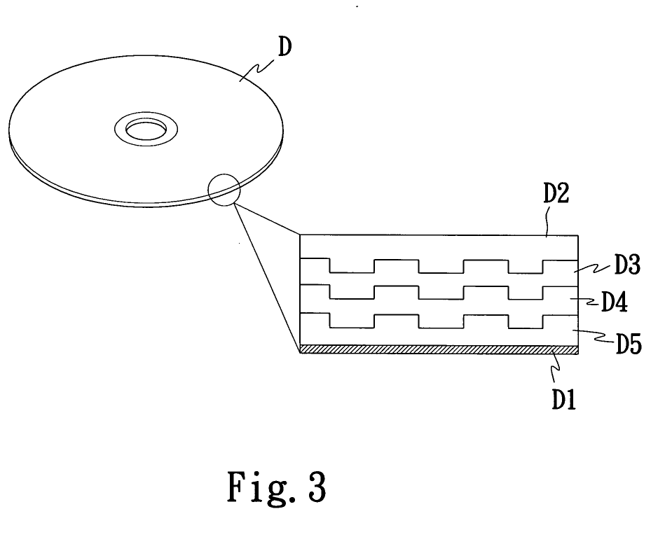

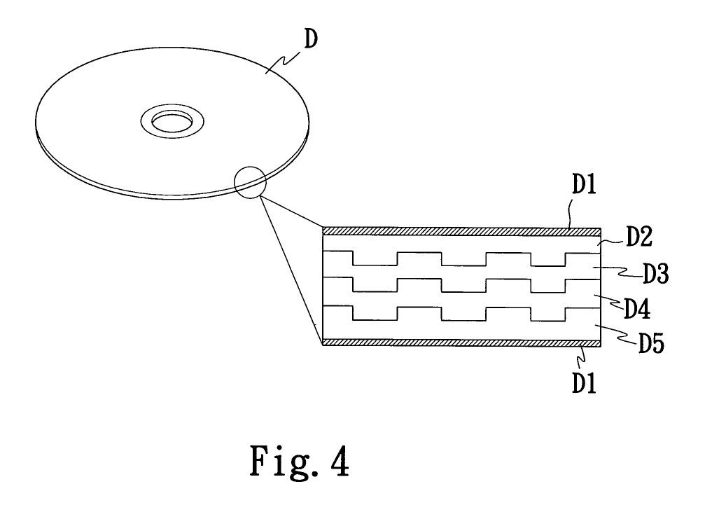

FIG. 3 shows a second example of application of the process of the present invention to a general compact disk D. In this second example, a light transmissible film D1 is coated on one side of the compact disk D. The compact disk D generally includes a bottom substrate D5 for protecting a record layer and serving as an imprinting side; a reflection layer D4 coated on a top of the substrate D5 to reflect laser light signals; a dye layer D3 coated on a top of the reflection layer D4 to absorb laser lights and thereby form pits thereon as records; and an upper substrate D2 coated on a top of the dye layer D3 to allow laser lights from a laser read-write head to project therethrough for reading data on the compact disk. The light transmissible film D1 is coated on an outer side of the bottom substrate D5 to protect the latter against scratch and wearing. FIG. 4 shows a third example of application of the process of the present invention to a general compact disk D. In this third example, a light transmissible film D1 is coated on each of two sides of the compact disk D. The compact disk D generally includes a bottom substrate D5 for protecting a record layer and serving as an imprinting side; a reflection layer D4 coated on a top of the substrate D5 to reflect laser light signals; a dye layer D3 coated on a top of the reflection layer D4 to absorb laser lights and thereby form pits thereon as records; and an upper substrate D2 coated on a top of the dye layer D3 to allow laser lights from a laser read-write head to project therethrough for reading data on the compact disk. The two light transmissible films D1 are separately coated on outer sides of the upper and the bottom substrate D2, D5 to protect the two substrates against scratch and wearing.

What is claimed is:

1. A process of forming special protecting structure for optical products, said special protecting structure being a protecting film formed on at least one surface of an optical product through spin coating of a specific material on said surface, and said specific material consisting of predetermined types of resin, monomer, photosensitizer, and assistant; said process comprising the steps of:
Step 1: Having the specific material evenly coated on at least one surface of said optical product, and spinning said optical product;
Step 2: Performing a first spinning with an acceleration time from 0.3 to 2.0 seconds, a spin speed from 300 to 900 rpm, and a step time from 0.3 to 1.5 seconds;
Step 3: Performing a second spinning with an acceleration time from 0.3 to 2.0 seconds, a spin speed from 1500 to 2200 rpm, and a step time from 0.3 to 1.5 seconds;
Step 4: Performing a third spinning with an acceleration time from 0.3 to 2.0 seconds, a spin speed from 2500 to 3200 rpm, and a step time from 0.3 to 1.5 seconds;
Step 5: Performing a fourth spinning with an acceleration time from 0.3 to 2.0 seconds, a spin speed from 50 to 100 rpm, and a step time from 0.3 to 1.5 seconds, and then stopping the spinning;
Step 6: Drying the specific material spin coated on the at least one surface of the optical product by exposing it to ultraviolet rays;
Step 7: Forming a uniform protecting film; and
Step 8: Ending the process.

2. The process as claimed in claim 1, wherein said protecting film is light transmissible, scratchproof, and wear-resistant, and is formed on each of two surfaces of said optical product.

3. The process as claimed in claim 1, wherein an amount of the resin presented in the specific material is in the range between 20% and 50%, the monomer between 10% and 30%, the photosensitizer between 1% and 15%, and the assistant between 0.5% and 5%.

4. The process as claimed in claim 3, wherein the resin contained in the specific material is selected from the group consisting of epoxy acrylic ester, phenolic resin, polymethyl acrylic resin, and any combinations thereof.

5. The process as claimed in claim 3, wherein the monomer contained in the specific material is selected from the group consisting of TMPTA, TPGDA, and HDDA.

6. The process as claimed in claim 3, wherein the photosensitizer contained in the specific material is selected from the group consisting of BDK, IRGACURE-907, ITX, BMS, IGGACURE-1173, and DETX.

7. The process as claimed in claim 3, wherein the assistant contained in the specific material is selected from the group consisting of wax, fluorine-containing smoothening agent, silicone-type smoothening agent, and organic silicon type assistant.

8. The process as claimed in claim 2, wherein said optical product is a compact disk, and said compact disk including an upper substrate allowing laser lights from a laser read-write head to project therethrough; a dye layer coated on one side of said upper substrate to absorb laser lights that form pits on said dye layer as records; a reflection layer coated on one side of said dye layer opposite to said upper substrate to reflect laser light signals; and a bottom substrate coated on one side of said reflection layer opposite to said dye layer for protecting a record layer and serving as an imprinting side; and wherein said light transmissible protecting film is selectively formed on any one of the following positions: an outer side of said upper substrate opposite to said dye layer; an outer side of said bottom substrate opposite to said reflection layer; and an outer side of both said upper and said bottom substrate opposite to said dye and said reflection layer, respectively.
